(19) United States
(12) Patent Application Publication
(10) Pub. No.: US 2009/0282180 A1
(43) Pub. Date: Nov. 12, 2009

(54) Plug-and-play hard disk read/write drive

(76) Inventor: Ricky Kuan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,633

(22) Filed: May 6, 2008

(51) Int. Cl. G06F 13/00

(52) U.S. Cl. 710/302

(57) ABSTRACT

A plug-and-play hard disk read/write drive includes a body, a control circuit board, and a connecting interface unit. The body has hard disk insertion slots and a power supply unit. The control circuit board is arranged in the body and is electrically connected with the connecting interface. The connecting interface unit has hard disk adapting interfaces corresponding to the hard disk insertion slots. The hard disk adapting interface has a first connecting end and a second connecting end. The hard disk is accommodated in the hard disk insertion slot, and is connected to the hard disk adapting interface. The power supply unit is electrically connected on the control circuit board for controlling a power switch of the connecting interface unit. The present invention allows the hard disks of different specifications to be accommodated in the hard disk read/write drive for transmitting and accessing data via the hard disk adapting interface.

### BACKGROUND OF THE INVENTION

1. Field of the Invention

The present invention relates to a hard disk read/write drive, and in particular to a plug-and-play hard disk read/write drive in which hard disk adapting interfaces of different specifications can be provided in one device to electrically connect the hard disks in a hot-plugging manner, thereby accessing and transmitting data to an internal device.

2. Description of Related Art

General hard disk interface devices adapt Integrated Device Electronics (IDE). After a computer is connected with a disk driver of the hard disk interface device, the process of storing and reading data is performed in the disk driver. The hard disk driver is the most popular data storage device in recent years. With the rapid development of technologies, Serial Advanced Technology Attachment (SATA) has been developed, whereby data transmission is rapid, connection is convenient, and the adapting interface is compact. Therefore, the conventional hard disk driver of single interface specification is not applicable to various kinds of hard disk drivers. Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a plug-and-play hard disk read/write drive. With a control circuit board provided in a body and the body being provided with at least one or plural hard disk insertion slots, the hard disk can be accommodated in the body to achieve a hot-plugging electrical connection with a connecting interface unit of the control circuit board. When the hard disk of different specification is accommodated in the hard disk insertion slot, it is convenient to achieve the electrical connection with the hard disk adapting interface of the connecting interface unit. Via the above structure, the hard disks of different specifications can be electrically connected in the hard disk read/write drive in a hot-plugging manner, so that the process of transmitting and accessing the data stored in the hard disk can be performed in the hard disk read/write drive. Further, the complicated installation of an internal electrical device and the hard disk can be avoided.

The other object of the present invention is to allow hard disks of different specifications to access and transmit data to a computer/notebook via the connection between a hard disk adapting interface and a computer communication interface. With a connection between the hard disk adapting interface and a network communication interface, the functions of a NAS/NDAS can be achieved by means of Internet, thereby allowing a remote user to access and transmit data of hard disk. The connection between the hard disk adapting interface and a multimedia communication interface can be used as an audio/video player to play multimedia audio/video data in the hard disk.

In order to achieve the above objects, the present invention provides a plug-and-play hard disk read/write drive, which includes a body, a control circuit board, and a connecting interface unit. The body has at least one hard disk insertion slot and a power supply unit. The hard disk insertion slot allows a hard disk to be accommodated therein. The control circuit board plate is provided in the body. The connecting interface unit is electrically connected on the control circuit board. The connecting interface unit has at least one hard disk adapting interface corresponding to the hard disk insertion slot. When the hard disk is accommodated in the hard disk insertion slot, it is electrically connected to the hard disk adapting interface. The power supply unit is provided on the surface of the body and is electrically connected on the control circuit board, thereby controlling a power switch of the connecting interface unit. The hard disk adapting interface has a first connecting end and a second connecting end. The first connecting end conforms to SATA interface specification. The second connecting end conforms to IDE interface specification. The hard disk is electrically connected to the first and second connecting ends selectively.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is a perspective view showing the first embodiment of the present invention;

FIG. 2 is a top view showing the first embodiment of the present invention;

FIG. 3 is a front view showing the first embodiment of the present invention;

FIG. 4 is a rear view showing the first embodiment of the present invention;

FIG. 5 is a perspective view showing the plug-and-play hard disk read/write drive being cooperated with the hard disk;

FIG. 6 is a block view showing the first embodiment of the present invention;

FIG. 7 is a block view showing the first embodiment of the present invention being connected with an external communication apparatus;

FIG. 8 is a perspective view showing the second embodiment of the present invention;

FIG. 9 is a block view showing the second embodiment of the present invention; and

FIG. 10 is a perspective view showing the third embodiment of the present invention being cooperated with the hard disk.

### DETAILED DESCRIPTION OF THE PREFERRED EMBODIMENTS

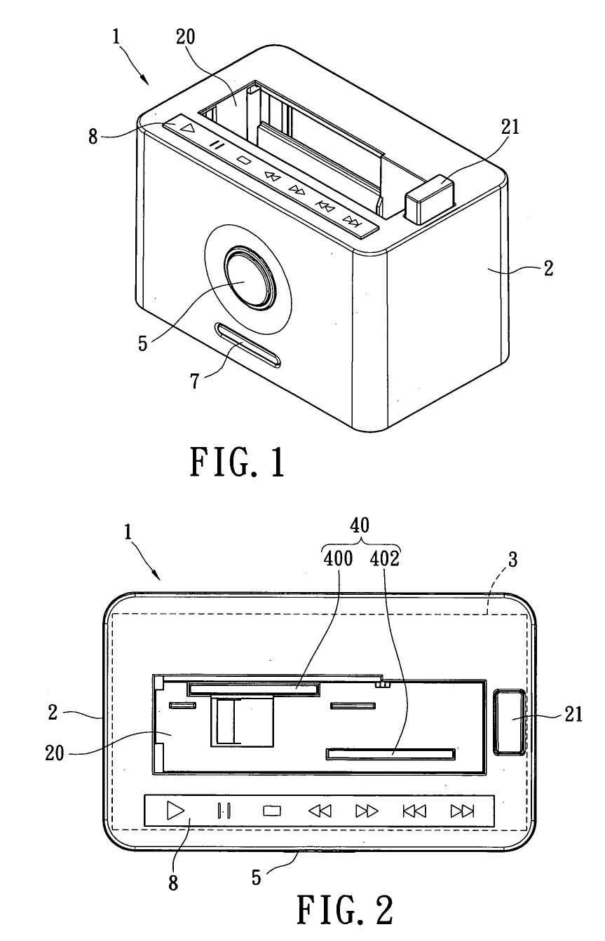

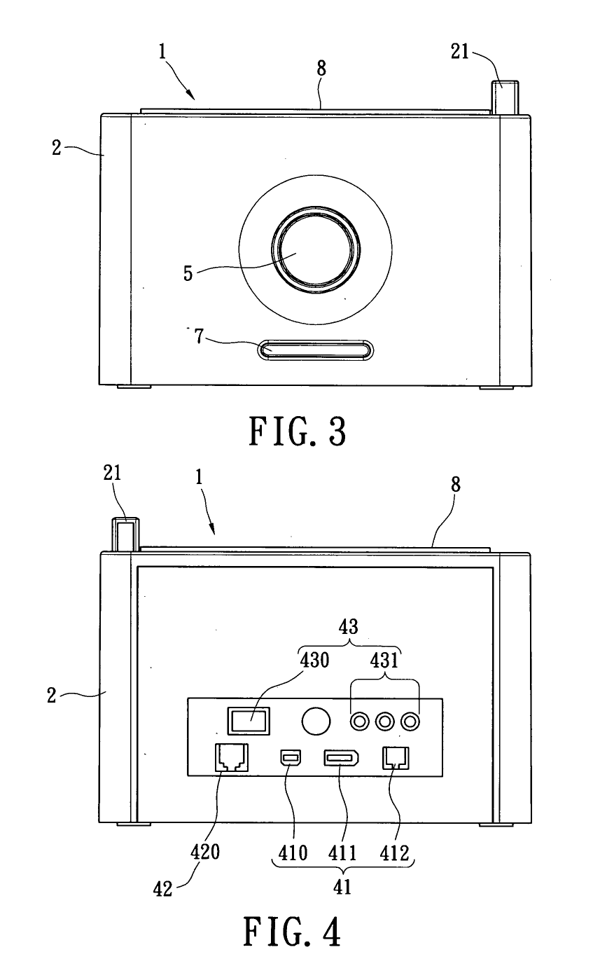

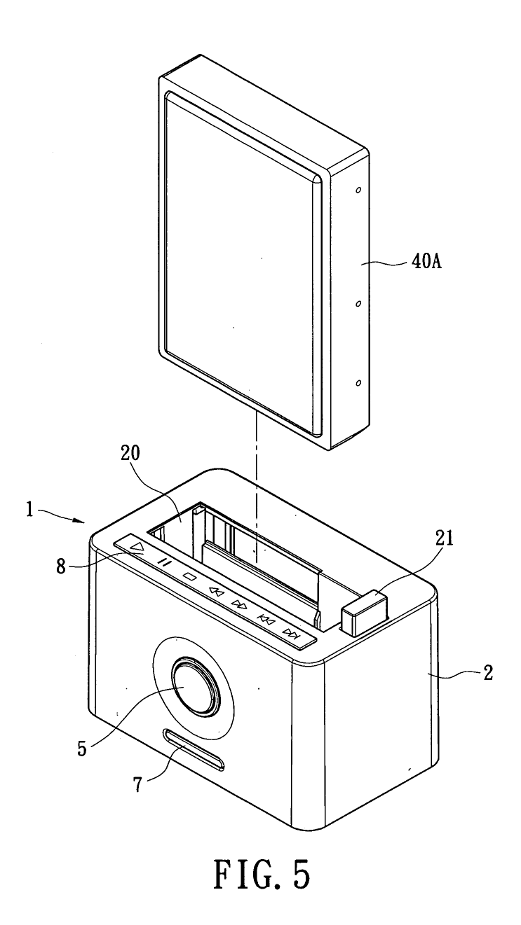

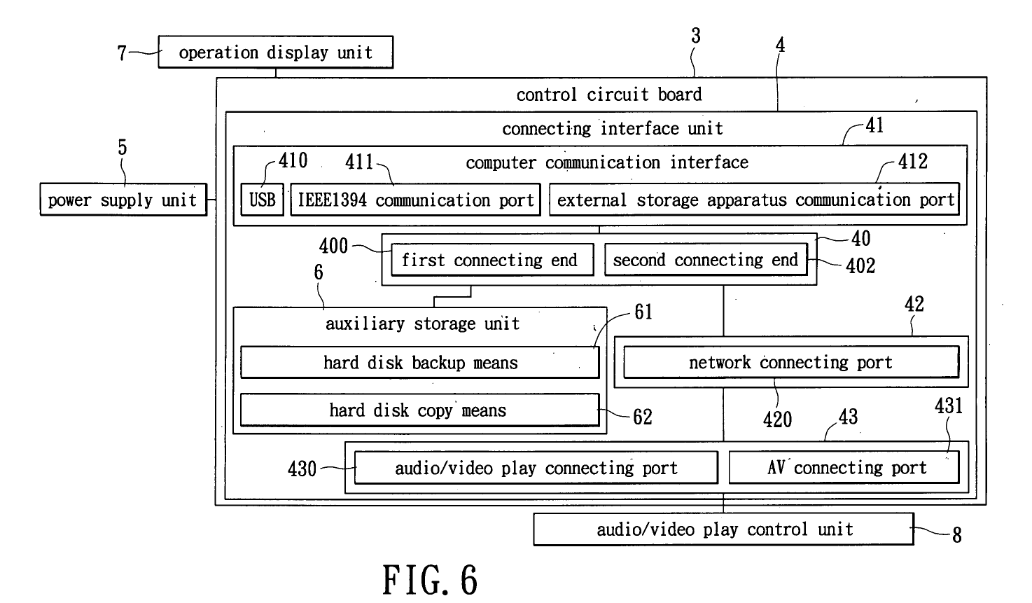

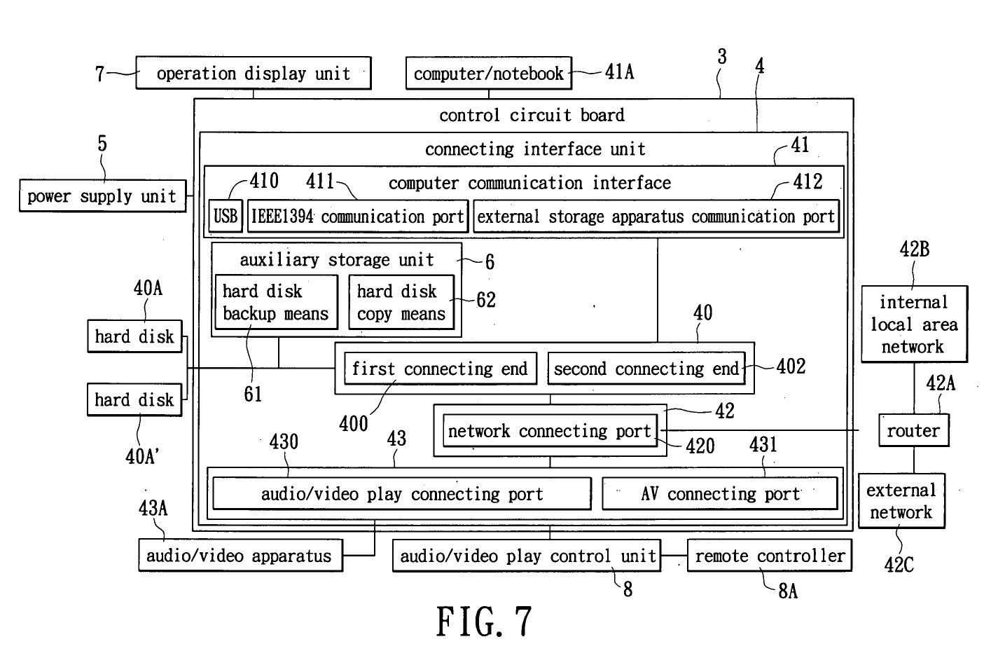

Please refer to FIGS. 1 to 7, which show the first embodiment of the plug-and-play hard disk read/write drive of the present invention. The present invention is used to allow a hard disk 40A (or hard disk 40A′, the hard disk 40A is used as an example hereinafter) to be electrically connected to a hard disk read/write drive 1 in a hot-plugging manner. In the present embodiment, the hard disk read/write drive 1 is a portable read/write drive 1 which allows a user to carry about and access data conveniently. As shown in FIGS. 6 and 7, the hard disk read/write drive 1 includes a body 2, a control circuit board 3, and a connecting interface unit 4. The control circuit board 3 is accommodated in the body 2. The connecting interface unit 4 is electrically connected on the control circuit board 3, thereby serving as a communication interface for accessing and transmitting data.

The body 2 has a hard disk insertion slot 20 and a hard disk ejection button 21. The hard disk insertion slot 20 allows the hard disk 40A to be accommodated in the body 2. The hard disk ejection button 21 serves as a means for ejecting the hard disk to interrupt and separate the electrical connection between the hard disk 40A and the connecting interface unit 4, so that the hard disk 40A can be ejected from the interface of the connecting interface unit 4. The body 2 is provided with a power supply unit 5, an auxiliary storage unit 6, an operation display unit 7, and an audio/video play control unit 8 (FIG. 6), thereby transmitting the data in the hard disk, accessing and playing associated operations, and providing power.

The power supply unit 5 is provided at a front end of the body 2, and is electrically connected on the control circuit board 3, thereby controlling the power switch of the connecting interface unit 4 and turning on/off the power supply between the hard disk 40A and the connecting interface unit 4.

The auxiliary storage unit 6 is provided on the control circuit board 3, and is electrically connected to the connecting interface unit 4, thereby transmitting and accessing data from the hard disk 40A to the connecting interface unit 4 and vice versa. The auxiliary storage unit 6 has a hard disk backup means 61 and a hard disk copy means 62 (FIG. 6). The hard disk backup means 61 is used to copy the data of the hard disk 40A and store the data in the computer/notebook 41A (FIG. 7) selectively. The hard disk copy means 62 is used to copy the data stored in any two hard disks 40A with each other. The operation of the hard disk copy means 62 has to be coordinated with at least two hard disks 40A in order to achieve complete copying.

The operation display unit 7 is provided at the front end of the body 2 and is electrically connected on the control circuit board 3, thereby displaying the operating state of the hard disk 40A and the connecting interface unit 4, and allowing the user to understand whether the hard disk 40A is turned on and operating or not.

The audio-video play control unit 8 is provided on the top end of the body 2, and is electrically connected to the connecting interface unit 4. Via this arrangement, the user can manually operate the audio/video play control unit 8, and control the data transmission between the hard disk 40A and the connecting interface unit 4 as well as the playing operation of the audio/video data of the hard disk 40A. Optionally, the user can control the audio/video play control unit 8 remotely via a remote controller 8A (FIG. 7), thereby achieving the same effect.

As shown in FIGS. 6 and 7, the connecting interface unit 4 is used to adapt the interface of the hard disk 40A and transmit and access data. In the present embodiment, the connecting interface unit 4 has a hard disk adapting interface 40, a computer communication interface 41, a network communication interface 42 and a multimedia communication interface 43.

The hard disk adapting interface 40 corresponds to the hard disk insertion slot 20 of the body 2, thereby allowing the insertion of various hard disks 40A of different interfaces (such as an 2.5-inch or 3.5-inch hard disk) and the data transmission. The hard disk adapting interface 40 has a first connecting end 400 and a second connecting end 402. The first connecting end 400 conforms to SATA interface specification, and the second connecting end 402 conforms to IDE interface specification. Via this arrangement, the hard disk 40A can be electrically connected to the first connecting end 400 or the second connecting end 402 selectively. The user can insert the hard disk 40A (or hard disk 40A′) of different specifications (such as IDE or SATA specification) into the hard disk insertion slot 20, so that the hard disk 40A can be electrically connected to the hard disk adapting interface 40 directly, thereby transmitting the data, facilitating the plug-and-play operation of the hard disk 40A, and avoiding the installation of associated hardware or software.

The computer communication interface 41 is electrically connected to the hard disk adapting interface 40, which has a USB 410, a IEEE1394 port 411, and an external storage apparatus (External Serial ATA, Esata) port 412, thereby serving as an interface for transmitting data to the computer/notebook 41A (FIG. 7). The user can transmit and access data between the hard disk 40A and the computer/notebook 41A via any transmission interface (USB, IEEE 1394 or SATA).

The network communication interface 42 is electrically connected to the hard disk adapting interface 40. The network communication interface 42 has a network connecting port 420 for allowing the hard disk adapting interface 40 to be connected to Internet, so that the hard disk 40A can achieve an effect of accessing and transmitting data via the Internet indirectly (i.e., like a NAS/NDAS). As shown in FIG. 7, the network connecting port 420 is connected to an internal local area network 42B and an external local area network 42C respectively via a router 42A, thereby forming a NAS/NDAS. Thus, a remote user (whoever located at the internal network end or external network end) can transmit or access data to/from the hard disk 40A via Internet.

The multimedia communication interface 43 is electrically connected to the hard disk adapting interface 40, which has an audio/video play connecting port 430 and an AV connecting port 431, thereby connecting to an audio/video apparatus 43A (FIG. 7). Via this arrangement, the user can play and transmit the audio/video data stored in the hard disk 40A.

Specifically, the interior of the body 2 is provided with a hard disk fixing structure (not shown) for fixing the hard disk 40A to the hard disk insertion slot 20 to guarantee a steady electrical connection in accessing and transmitting data between the hard disk 40A and the hard disk adapting interface 40. Via this arrangement, a data protection mechanism can be formed to avoid unexpected or unnecessary vibrations in reading the hard disk so as to cause poor electrical connection and damage to data.

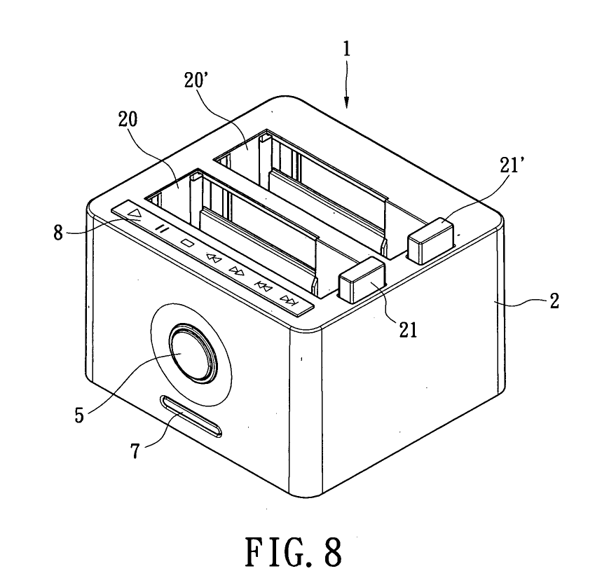

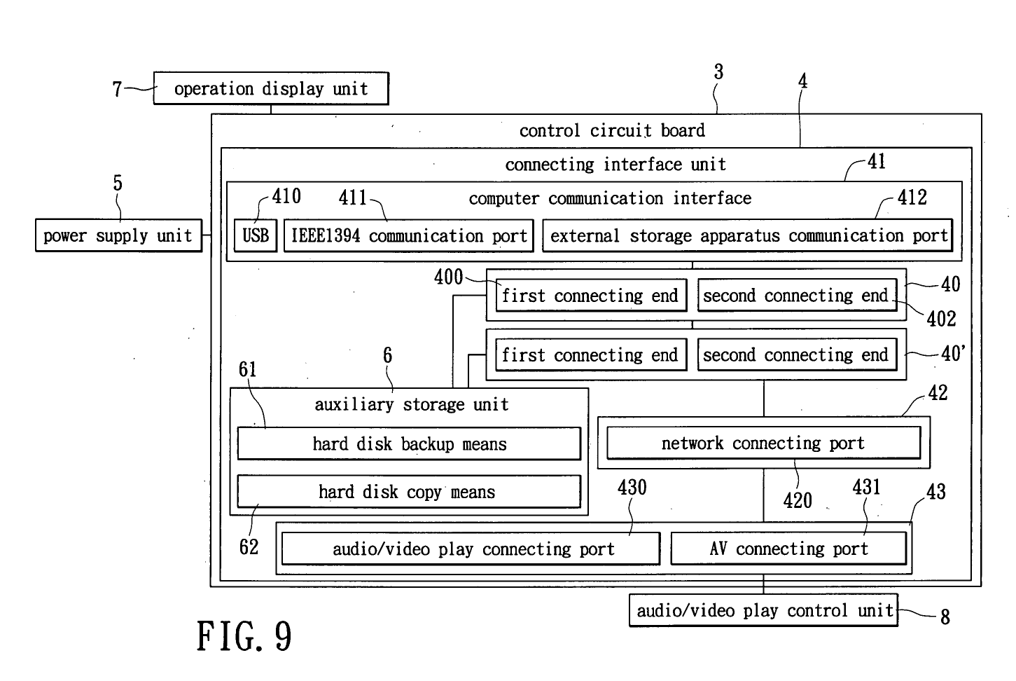

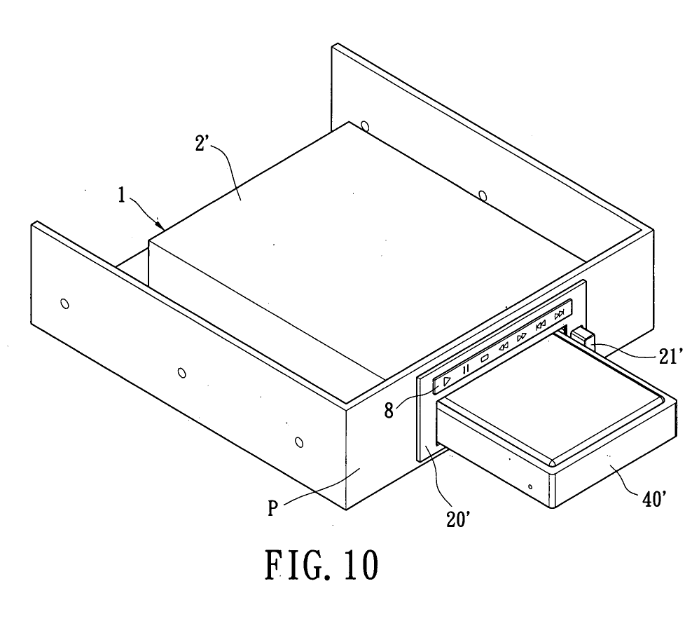

Please refer to FIGS. 8 and 9, which are a perspective view and a block view of a second embodiment of the plug-and-play hard disk read/write drive of the present invention respectively. The difference between the second embodiment and the first embodiment lies in that, in the present embodiment, the body 2 of the hard disk read/write drive 1 has two hard disk insertion slots 20, 20′ and two hard disk ejection buttons 21, 21′. Accordingly, the connecting interface unit 4 also has two hard disk adapting interfaces 40, 40′. Each of the hard disk adapting interfaces 40, 40′ corresponds to each of the hard disk insertion slots 20, 20′, so that two hard disks 40A, 40A′ can be inserted in the hard disk insertion slots 20, 20′ (FIG. 7) and are electrically connected with the hard disk adapting interfaces 40, 40′. The hard disk ejection button 21, 21′ is used as a means for ejection the hard disk, thereby separating the electrical connection between the hard disks 40A, 40A′ and the hard disk adapting interfaces 40, 40′ of the connecting interface unit 4. The hard disk copy means 62 of the auxiliary storage unit 6 is used to copy the data stored in any two hard disks 40A, 40A′ with each other. The structures and operations of other associated members are the same as those of the previous embodiment, and thus are omitted for simplicity.

Please refer to FIG. 10, which is a perspective view showing the third embodiment of the plug-and-play hard disk read/write drive of the present invention cooperating with a hard disk. The difference between the third embodiment and the previous two embodiments lies in that the hard disk read/write drive 1 of the present embodiment is a lodged-in hard disk read/write drive 1. The body 2′ is detachably mounted on a computer panel P. With the hard disk being inserted in the hard disk insertion slot 20′ directly, the hard disk 40A′ can be electrically connected with an external electronic device (such as computer, multimedia audio/video apparatus or a remote electronic device) via the hard disk read/write drive 1, thereby achieving the effect of communicating and transmitting data. According to the above, the present invention has some advantages as follows.

(1) Single or Several 2.5-inch or 3.5-inch hard disks can be electrically connected to the hard disk adapting interface via a hot-plugging manner, thereby achieving a plug-and-play effect and eliminating the complicated installation of the hard disks and the external electronic device.

(2) With the connection between the hard disk adapting interface and the computer communication interface, the data in the hard disks of different specifications can be accessed and transmitted to and from a computer/notebook. With the connection between the hard disk adapting interface and the network communication interface, functions of a NAS/NDAS can be achieved via the Internet, so that a remote user can access and transmit data of the hard disk. The connection between the hard disk adapting interface and the multimedia communication interface can be also used as an audio/video player to play the multimedia audio/video data stored in the hard disk.

(3) The connection between the auxiliary storage unit and the connecting interface unit is used to copy the data of the hard disk and store the data in the computer/notebook selectively. Alternatively, the data stored in any hard disk can be copied with each other.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A plug-and-play hard disk read/write drive, allowing a hard disk to be electrically connected in a hot-plugging manner to achieve the transmission and access of data, characterized in that the plug-and-play hard disk read/write drive comprises:
a body having at least one hard disk insertion slot and a power supply unit, the hard disk insertion slot allowing the hard disk to be accommodated therein;
a control circuit board provided in the body; and
a connecting interface unit electrically connected on the control circuit board, the connecting interface unit having at least one hard disk adapting interface corresponding to the hard disk insertion slot, the hard disk being received in the hard disk insertion slot and electrically connected to the hard disk adapting interface;
wherein the power supply unit is provided on the surface of the body and electrically connected to the control circuit board to control a power switch of the connecting interface unit, the hard disk adapting interface has a first connecting end and a second connecting end, the first connecting end conforms to SATA interface specification, the second connecting end conforms to IDE interface specification, the hard disk is electrically connected to the first or second connecting ends selectively.

2. The plug-and-play hard disk read/write drive according to claim 1, characterized in that the connecting interface unit has a computer communication interface electrically connected to the hard disk adapting interface, the computer communication interface has at least one communication interfaces of USB, IEEE1394 and an external storage device (External Serial ATA, Esata).

3. The plug-and-play hard disk read/write drive according to claim 1, characterized in that the connecting interface unit has a network communication interface electrically connected to the hard disk adapting interface, and the internet communication interface has at least one network connecting port.

4. The plug-and-play hard disk read/write drive according to claim 1, characterized in that the connecting interface unit has a multimedia communication interface electrically connected to the hard disk adapting interface, and the multimedia communication interface has at least one audio/video play connecting port and at least one AV connecting port.

5. The plug-and-play hard disk read/write drive according to claim 1, characterized in that the body is provided with an auxiliary storage unit electrically connected to the connecting interface unit for executing transmission of data between the hard disk and the connecting interface unit, the auxiliary storage unit having a hard disk backup means for copying the data of the hard disk and storing the data in the computer.

6. The plug-and-play hard disk read/write drive according to claim 1, characterized in that the body is provided with an operation display unit electrically connected to the control circuit board, thereby displaying the operating states of the hard disk and the connecting interface unit.

7. The plug-and-play hard disk read/write drive according to claim 1, characterized in that the surface of the body has an audio/video play control unit electrically connected to the connecting interface unit, thereby transmitting data between the hard disk and the connecting interface unit.

8. The plug-and-play hard disk read/write drive according to claim 1, characterized in that the body has at least one hard disk ejection means for separating the electrical connection between the hard disk and the connecting interface unit.

9. The plug-and-play hard disk read/write drive according to claim 1, characterized in that the body has a plurality of hard disk insertion slots, the connecting interface unit has a plurality of hard disk adapting interfaces, each hard disk adapting interface corresponds to each hard disk insertion slot.

10. The plug-and-play hard disk read/write drive according to claim 9, characterized in that the body has a plurality of hard disk ejection means, the hard disk ejection means are used to separate the electrical connection between the hard disks and the connecting interface unit.

11. The plug-and-play hard disk read/write drive according to claim 9, characterized in that the surface of the body is provided with an auxiliary storage unit electrically connected to the connecting interface unit for executing transmission of data between the hard disks and the connecting interface unit, the auxiliary storage unit has a hard disk backup means for copy the data of the hard disks and a hard disk copy means for copying any two hard disks with each other.
